(19) United States
(12) Patent Application Publication
(10) Pub. No.: US 2010/0002566 A1
(43) Pub. Date: Jan. 7, 2010

(54) INFORMATION RECORDING MEDIUM, AND METHOD OF MANUFACTURING INFORMATION RECORDING MEDIUM

(75) Inventors: Akira Shirota, Tokorozawa-shi (JP); Akira Shimizu, Tokorozawa-shi (JP); Tsuyoshi Hasebe, Tokorozawa-shi (JP); Masahiro Kato, Tokorozawa-shi (JP); Shoji Taniguchi, Tokorozawa-shi (JP); Atsushi Kondo, Tokorozawa-shi (JP); Yukihiro Sugawara, Tokorozawa-shi (JP); Masayoshi Yoshida, Tokorozawa-shi (JP)

Correspondence Address: YOUNG & THOMPSON, 209 Madison Street, Suite 500, Alexandria, VA, 22314, US

(73) Assignee: PIONEER CORPORATION, TOKYO (JP)

(21) Appl. No.: 12/446,950

(22) PCT Filed: Oct. 27, 2006
(86) PCT No.: PCT/JP2006/321539

§ 371 Date: Jun. 19, 2009

(51) Int. Cl. G11B 7/24; B44C 1/22

(52) U.S. Cl. 369/275.4; 216/22; G9B/7

(57) ABSTRACT

An information recording medium (100) is an optical recording medium in which a groove is made along a recording track and record or reproduction is carried out by irradiating laser light to it and a push-pull signal, which is smaller than a prescribed value, is obtained from a part of a region (101a) of the groove.

### TECHNICAL FIELD

The present invention relates to an information recording medium such as a DVD and a BD (Blu-ray Disc), and a method of manufacturing the information recording medium.

### BACKGROUND ART

A patent document 1 or the like discloses a distribution system; in which recording-type information recording media such as DVD-R/RWs are sold with encryption information pre-recorded; and in which encrypted DVD video contents (hereinafter referred to as “encrypted contents” as occasion demands) are distributed through a network. In the distribution system, the encryption information applied to conventional read-only type media such as DVD-ROMs is pre-recorded before sale in a control area, such as a control data zone, on information recording media having the same physical structure as that of the conventional recording-type information recording media such as DVD-R/RWs.

Moreover, the conventional recording-type information recording media (recording-type media) are designed as follows; namely, in the recording-type information recording media, firstly, contents such as movie contents that allow arbitrary copy, which does not require copyright protection, i.e. copy-free contents, can be recorded on the basis of a DVD-Video format, and then, a finalize process can be performed. In addition, in the finalized recording-type information recording media, the reproduction can be performed while maintaining reproduction compatibility by conventional players (general information recording/reproducing apparatuses) such as DVD players.

On the one hand, in the DVD-Video format, copyright protection is realized by an encryption system such as CSS (Content Scramble System). Specifically, if contents whose copyright is protected by the CSS are recorded on the recording-type information recording media, a reproduction restriction system for the copyright protection of the players does not allow the contents to be reproduced from the recording-type information recording media, and it uniformly forbids the reproduction of the contents. This is because, in general, the conventional players recognize that the contents whose copyright is protected by the CSS are pre-recorded only on the read-only information recording media such as a DVD-ROM. Thus, the conventional players judge that illegal content copy is performed if the contents whose copyright is protected by the CSS are recorded on the recording-type information recording media. The reproduction restriction system does not allow the reproduction of the contents, and it uniformly forbids the reproduction of the contents. Incidentally, some players judge whether or not to be the recording-type information recording media, (i) on the basis of whether or not a signal from wobble unique to the recording-type information recording media (hereinafter referred to as a “wobble signal” as occasion demands) is detected, or (ii) on the basis of whether or not a push-pull signal is detected from a reproduction signal obtained from the information recording media; or on the basis of the measurement of a push-pull signal detection level (refer to a patent document 2 or the like).

Patent document 1: Japanese Patent Application Laid Open NO. 2001-307427
Patent document 2: Japanese Patent Application Laid Open NO. Hei 08-235765

### DISCLOSURE OF INVENTION

### Subject to be Solved by the Invention

In cases where an information reproducing apparatus judges a media type in a seek operation or the like for obtaining control information, the information reproducing apparatus judges the type of the information recording medium; on the basis of whether or not a push-pull signal is detected from a reproduction signal obtained from the information recording medium; or on the basis of the measured push-pull signal detection level, as described above, in some cases. If the contents whose copyright is protected by the CSS are recorded on the recording-type information recording medium, there is such a problem that even if the contents are legally recorded, the information reproducing apparatus judges that they are illegally copied contents and does not allow the reproduction for the aforementioned reasons in some cases.

In view of the aforementioned problems, it is therefore an object of the present invention to provide an information recording medium which achieves a balance between protecting copyright for the record data, such as contents, on the recording-type information recording medium and maintaining compatibility with the read-only type information recording medium.

### Means for Solving the Subject

The above object of the present invention can be achieved by an information recording medium according to claim 1; which is an optical recording medium; in which a groove is formed along a recording track; and which is irradiated with a laser beam for recording or reproduction, wherein a push-pull signal less than a predetermined value, is obtained from at least a partial area of the groove.

The above object of the present invention can be also achieved by a method of manufacturing an information recording medium, according to claim 15; in which a groove is formed along a recording track; and which is irradiated with a laser beam for recording or reproduction; wherein a push-pull signal less than a predetermined value, is obtained from at least a partial area of the groove, the method provided with: a changing process of changing a depth or width of the groove in the partial area; and an adjusting process of adjusting the push-pull signal obtained from the changed partial area to be less than the predetermined value.

### BEST MODE FOR CARRYING OUT THE INVENTION

### Embodiment of Information Recording Medium

Hereinafter, an information recording medium in an embodiment of the present invention will be explained.

An embodiment of the information recording medium of the present invention is an information recording medium; which is an optical recording medium; in which a groove is formed along a recording track; and which is irradiated with a laser beam for recording or reproduction, wherein a push-pull signal less than a predetermined value, is obtained from at least a partial area (a reproduction setting area) of the groove.

According to the embodiment of the information recording medium of the present invention, for example, at least one recording layer is laminated on a disc-shaped substrate. In a recording area in the recording layer, for example, information such as audio, video information, content information, or user data can be recorded or reproduced through the groove or groove track, i.e. the recording track, by using the laser beam with a wavelength of 650 nm.

Moreover, the groove track is formed such that the push-pull signal less than the predetermined value is detected from at least the partial area of the groove track.

Therefore, if an information reproducing apparatus uses the partial area as the reproduction setting area in order to judge the type of the information recording medium when reproducing the information recording medium of the present invention, the signal is detected that is less than the push-pull signal obtained from a normal recording type information recording medium. The “reproduction setting area” of the present invention herein denotes an area which is firstly accessed when the recorded record information such as record data is reproduced, which allows the judgment of whether or not to allow the reproduction of the record information, and which is to identify whether or not to be recording media.

Thus, the information recording medium of the present invention is judged to be not the recording type information recording medium but a read-only information recording medium, such as a DVD-ROM. As a result, a conventional player can perform a reproduction process on the information recording medium of the present invention, as in the general read-only information recording medium.

In one aspect of the embodiment of the information recording medium of the present invention, the push-pull signal obtained from the partial area after recording, is less than the predetermined value.

According to this aspect, if the information reproducing apparatus uses the partial area after recording (in other words, in a recorded status) in order to judge the type of the information recording medium when reproducing the information recording medium of the present invention, the signal is detected that is less than the push-pull signal obtained from the normal recording type information recording medium. Thus, the information recording medium of the present invention is judged to be not the recording type information recording medium but the general read-only information recording medium, such as a DVD-ROM. As a result, the conventional player can perform the reproduction process on the information recording medium of the present invention after recording, as in the general read-only information recording medium.

In another aspect of the embodiment of the information recording medium of the present invention, the predetermined value is a detection amount of the push-pull signal determined in a DVD-R standard or DVD-RW standard.

According to this aspect, if the information reproducing apparatus uses the partial area in order to judge the type of the information recording medium when reproducing the information recording medium of the present invention, the signal is detected that is less than the push-pull signal obtained from the recording type information recording medium according to the DVD-R standard or DVD-RW standard. Thus, the information recording medium of the present invention is judged to be not the recording type information recording medium according to the DVD-R standard or DVD-RW standard but the read-only information recording medium, such as a DVD-ROM. As a result, the conventional player can perform the reproduction process on the information recording medium of the present invention, as in the general read-only information recording medium.

In another aspect of the embodiment of the information recording medium of the present invention, the predetermined value is a detection amount of the push-pull signal determined in a DVD+R standard or DVD+RW standard.

According to this aspect, if the information reproducing apparatus uses the partial area in order to judge the type of the information recording medium when reproducing the information recording medium of the present invention, the signal is detected that is less than the push-pull signal obtained from the recording type information recording medium according to the DVD+R standard or DVD+RW standard. Thus, the information recording medium of the present invention is judged to be not the recording type information recording medium according to the DVD+R standard or DVD+RW standard but the read-only information recording medium, such as a DVD-ROM. As a result, the conventional player can perform the reproduction process on the information recording medium of the present invention, as in the general read-only information recording medium.

In an aspect associated with the predetermined value, the predetermined value may be equal to “0.22”; if the push-pull signal detected from the partial area after recording, is normalized by an entire amount of light detected from the partial area after recording.

By virtue of such construction, if the information reproducing apparatus uses the partial area after recording (in other words, in a recorded status) in order to judge the type of the information recording medium when reproducing the information recording medium of the present invention, the signal is detected that is less than the predetermined value, which is equal to “0.22”; if the push-pull signal detected from the partial area after recording is normalized by the entire amount of light detected from the partial area after recording. Thus, the information recording medium of the present invention is judged to be not the recording type information recording medium but the read-only information recording medium, such as a DVD-ROM. As a result, the conventional player can perform the reproduction process on the information recording medium of the present invention after recording, as in the general read-only information recording medium.

In another aspect of the embodiment of the information recording medium of the present invention, the partial area is in a radial range of “22.3 to 35.0 (mm: millimeter)” from the center of the information recording medium.

According to this aspect, it is possible to make the partial area function as the reproduction setting area which is firstly accessed when the recorded record information such as record data is reproduced, which allows the judgment of whether or not to allow the reproduction of the record information, and which is to identify whether or not to be recording media. As a result, the conventional player can access the partial area that functions as the reproduction setting area, quickly and appropriately, and it can perform the reproduction process on the information recording medium of the present invention, more quickly and appropriately, as in the general read-only information recording medium.

In another aspect of the embodiment of the information recording medium of the present invention, the partial area is an area that is not included in a data area.

According to this aspect, various information such as content information can be appropriately recorded in the data area on the basis of a recording method and an encryption method which are substantially the same as conventional ones.

In an aspect associated with the partial area, the partial area may be included in a lead-in area.

By virtue of such construction, it is possible to make the partial area function as the lead-in area which is firstly accessed when the recorded record information such as record data is reproduced, which allows the judgment of whether or not to allow the reproduction of the record information, and which is to identify whether or not to be recording media. As a result, the conventional player can access the partial area that functions as the lead-in area, quickly and appropriately, and it can perform the reproduction process on the information recording medium of the present invention, more quickly and appropriately, as in the general read-only information recording medium.

In an aspect associated with the partial area, the partial area may be included in a CDZ (control data zone)

By virtue of such construction, it is possible to make the partial area function as the CDZ (control data zone) which is firstly accessed when the recorded record information such as record data is reproduced, which allows the judgment of whether or not to allow the reproduction of the record information, and which is to identify whether or not to be recording media. As a result, the conventional player can access the partial area that functions as the CDZ (control data zone), quickly and appropriately, and it can perform the reproduction process on the information recording medium of the present invention, more quickly and appropriately, as in the general read-only information recording medium.

In another aspect of the embodiment of the information recording medium of the present invention, a straight groove is formed in the partial area.

According to this aspect, if the information reproducing apparatus uses the partial area in order to judge the type of the information recording medium when reproducing the information recording medium of the present invention, the signal is detected that is less than the push-pull signal obtained from a recording type information recording medium with the straight groove formed. Thus, the information recording medium of the present invention is judged to be not the special recording type information recording medium with the straight groove formed, but the read-only information recording medium, such as a DVD-ROM. As a result, the conventional player can perform the reproduction process on the information recording medium of the present invention, as in the general read-only information recording medium.

In another aspect of the embodiment of the information recording medium of the present invention, wobble is formed in the partial area.

According to this aspect, if the information reproducing apparatus uses the partial area in order to judge the type of the information recording medium when reproducing the information recording medium of the present invention, the signal is detected that is less than the push-pull signal obtained from a recording type information recording medium with the wobble formed. Thus, the information recording medium of the present invention is judged to be not the recording type information recording medium with the wobble formed, but the read-only information recording medium, such as a DVD-ROM. As a result, the conventional player can perform the reproduction process on the information recording medium of the present invention, as in the general read-only information recording medium.

In another aspect of the embodiment of the information recording medium of the present invention, wobble with a wobble frequency substantially twice the wobble frequency determined in a DVD-R standard or DVD-RW standard, is formed in the partial area.

According to this aspect, if the information reproducing apparatus uses the partial area in order to judge the type of the information recording medium when reproducing the information recording medium of the present invention, the signal is detected that is less than the push-pull signal obtained from a recording type information recording medium in which the special wobble with a wobble frequency substantially twice the wobble frequency determined in the standard frequency, is formed. Thus, the information recording medium of the present invention is judged to be not the recording type information recording medium in which the special wobble with a wobble frequency substantially twice the wobble frequency determined in the standard frequency, is formed, but the read-only information recording medium, such as a DVD-ROM. As a result, the conventional player can perform the reproduction process on the information recording medium of the present invention, as in the general read-only information recording medium.

In another aspect of the embodiment of the information recording medium of the present invention, the push-pull signal less than the predetermined value, is obtained from an entire area (a reproduction setting area) of the groove.

According to this aspect, if the information reproducing apparatus uses the entire area in order to judge the type of the information recording medium when reproducing the information recording medium of the present invention, the signal is detected that is less than the push-pull signal obtained from the normal recording type information recording medium. Thus, the information recording medium of the present invention is judged to be not the recording type information recording medium but the read-only information recording medium, such as a DVD-ROM. As a result, the conventional player can perform the reproduction process on the information recording medium of the present invention, as in the general read-only information recording medium.

In another aspect of the embodiment of the information recording medium of the present invention, the push-pull signal obtained from the partial area, is less than a push-pull signal obtained from another partial area of the groove.

According to this aspect, if the information reproducing apparatus uses the partial area in order to judge the type of the information recording medium when reproducing the information recording medium of the present invention, the signal is detected that is less than the push-pull signal obtained from the normal recording type information recording medium. Thus, the information recording medium of the present invention is judged to be not the recording type information recording medium corresponding to another partial area of the groove, but the read-only information recording medium, such as a DVD-ROM. As a result, the conventional player can perform the reproduction process on the information recording medium of the present invention, as in the general read-only information recording medium.

(Embodiment of Method of Manufacturing An Information Recording Medium)

Hereinafter, a method of manufacturing an information recording medium in an embodiment of the present invention will be explained.

An embodiment of the method of manufacturing an information recording medium of the present invention is a method of manufacturing an information recording medium; in which a groove is formed along a recording track; and which is irradiated with a laser beam for recording or reproduction; wherein a push-pull signal less than a predetermined value, is obtained from at least a partial area of the groove, the method provided with: a changing process of changing a depth or width of the groove in the partial area (a reproduction setting area); and an adjusting process of adjusting the push-pull signal obtained from the changed partial area to be less than the predetermined value.

According to the embodiment of the method of manufacturing an information recording medium of the present invention, firstly, the depth or width of the groove in the partial area is changed in the changing process. Then, the depth or width of the groove in the partial area is adjusted in the adjusting process such that the push-pull signal obtained from the partial area is less than the predetermined value. Incidentally, in the adjustment of the depth or width of the groove in the partial area, the depth or width of the groove may be changed experimentally, experientially, theoretically, or by simulations, to obtain the push-pull signal, individually and specifically.

As a result, it is possible to manufacture the information recording medium in which the push-pull signal less than the predetermined value is obtained from at least the partial area of the groove, on the basis of the changing process and the adjusting process, more simply and highly accurately.

Incidentally, in response to the various aspects of the embodiment of the information recording medium of the present invention described above, the embodiment of the method of manufacturing an information recording medium of the present invention can also adopt various aspects.

In one aspect of the embodiment of the method of manufacturing an information recording medium of the present invention, the predetermined value is a detection amount of the push-pull signal determined in a DVD-R standard or DVD-RW standard.

According to this aspect, it is possible to manufacture the information recording medium in which the push-pull signal less than the predetermined value according to the DVD-R standard or DVD-RW standard is obtained from at least the partial area of the groove, on the basis of the changing process and the adjusting process, more simply and highly accurately.

In another aspect of the embodiment of the method of manufacturing an information recording medium of the present invention, the predetermined value is equal to “0.22”; if the push-pull signal detected from the partial area after recording is normalized by an entire amount of light detected from the partial area after recording.

According to this aspect, it is possible to manufacture the information recording medium in which the push-pull signal is obtained that is less than the predetermined value, which is equal to “0.22” if the push-pull signal detected from the partial area after recording is normalized by the entire amount of light detected from the partial area after recording, from at least the partial area of the groove, on the basis of the changing process and the adjusting process, more simply and highly accurately.

In another aspect of the embodiment of the method of manufacturing an information recording medium of the present invention, the changing process changes the width of the groove in the partial area to “½ (i.e. one halt)” or less of a track interval of the recording track, and the adjusting process adjusts the push-pull signal obtained from the changed partial area to be less than the predetermined value.

According to this aspect, it is possible to manufacture the information recording medium in which the push-pull signal less than the predetermined value is obtained from at least the partial area of the groove, on the basis of the changing process and the adjusting process, more simply and highly accurately, on the basis of the width of the groove in the partial area which is changed to “½ (i.e. one half)” or less of the track interval of the recording track.

In another aspect of the embodiment of the method of manufacturing an information recording medium of the present invention, the changing process changes the depth of the groove in the partial area to “¼ (i.e. a quarter or one-forth)” or less of the groove width, and the adjusting process adjusts the push-pull signal obtained from the changed partial area to be less than the predetermined value.

According to this aspect, it is possible to manufacture the information recording medium in which the push-pull signal less than the predetermined value is obtained from at least the partial area of the groove, on the basis of the changing process and the adjusting process, more simply and highly accurately, on the basis of the depth of the groove in the partial area which is changed to “¼” or less of the groove width.

As explained above, according to the embodiment of the information recording medium of the present invention, the groove is formed along the recording track, and the push-pull signal less than the predetermined value is obtained from at least the partial area (the reproduction setting area) of the groove. As a result, the conventional player can perform the reproduction process on the information recording medium of the present invention, as in the general read-only information recording medium.

According to the embodiment of the method of manufacturing an information recording medium of the present invention, it is provided with the changing process and the adjusting process. As a result, it is possible to manufacture the information recording medium in which the push-pull signal less than the predetermined value is obtained from at least the partial area of the groove, on the basis of the changing process and the adjusting process, more simply and highly accurately.

The operation and other advantages of the present invention will become more apparent from examples explained below.

### BRIEF DESCRIPTION OF DRAWINGS

FIG. 1 is a schematic plan view showing the basic structure of an optical disc having a plurality of recording areas in an example of the information recording medium of the present invention, and a schematic conceptual view showing a recording area structure in the radial direction associated with the cross sectional view.

FIG. 2 is a conceptual graph showing a relation between a recording area of the optical disc in the example of the information recording medium of the present invention and an address which can specify the position of the recording area.

FIG. 3 are graphs schematically showing a direction which changes the width and the depth of a groove in the example of the information recording medium of the present invention (FIG. 3(a) and FIG. 3(b)).

FIG. 4 are graphs schematically showing a change in the value of a push-pull signal and a change in the ratio of the value of the push-pull signal when the absolute value of the width or depth is defined in the example of the information recording medium of the present invention (FIG. 4(a) and FIG. 4(b)).

FIG. 5 are a table numerically showing a correlation among a pigment film thickness, a groove depth, a groove width, a track interval, a push-pull signal detection amount after recording, and a normalized push-pull signal value in the example of the information recording medium of the present invention (FIG. 5(a)), and a table showing a result when reproduction is tried by an information reproducing apparatus which can judge the type of an optical disc at a push-pull signal amplitude (detection level), with respect to the recording-type disc on which contents protected by CSS are recorded, in the example of the information recording medium of the present invention (FIG. 5(b)).

FIG. 6 is a block diagram showing the entire structure of an information recording/reproducing apparatus 200 in the example of the information recording medium of the present invention.

FIG. 7 is a schematic diagram schematically showing a procedure of manufacturing the information recording medium of the present invention.

### DESCRIPTION OF REFERENCE CODES

1 center hole
50 track
51 ECC block
100 optical disc
101 lead-in area
101a reproduction setting area
102 data area
103 lead-out area
200 information recording/reproducing apparatus
CDZ control data zone
RMA recording management area

### EXAMPLES

Hereinafter, examples of the present invention will be explained on the basis of the drawings.

### (1) First Example of Information Recording Medium

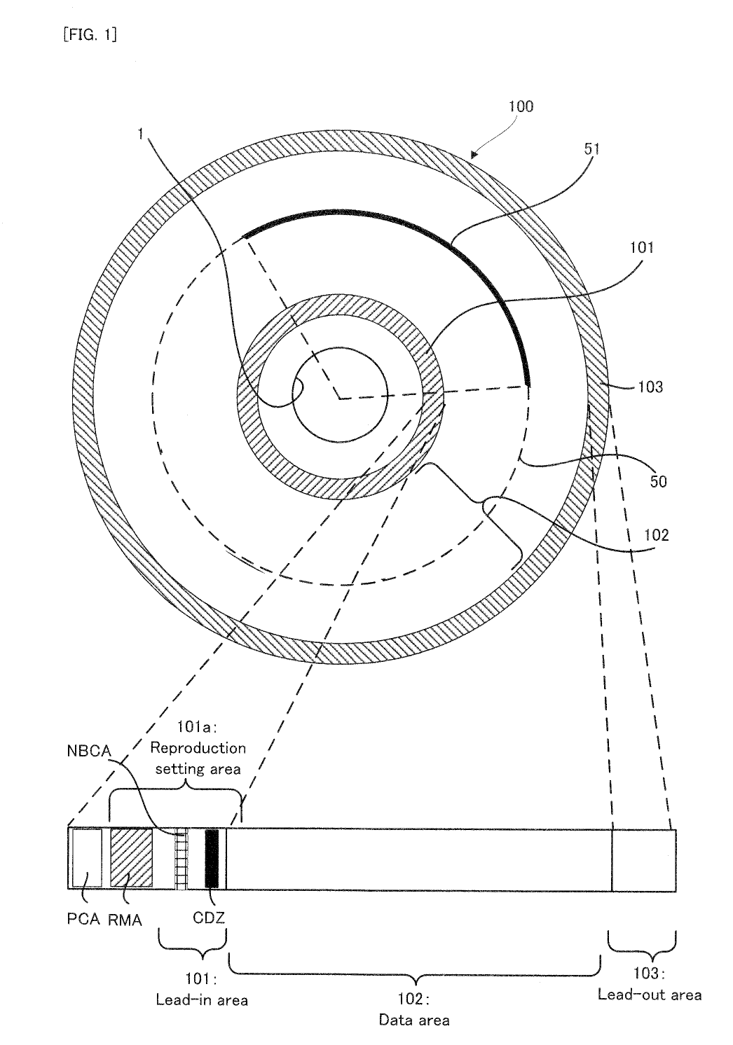

Next, with reference to FIG. 1 to FIG. 6, a first example of the information recording medium of the present invention will be explained in detail.

(1-1) Basic Structure

Firstly, with reference to FIG. 1, the basic structure of an optical disc in the example of the information recording medium of the present invention will be explained. FIG. 1 is a schematic plan view showing the basic structure of the optical disc having a plurality of recording areas in an example of the information recording medium of the present invention, and a schematic conceptual view showing a recording area structure in the radial direction associated with the cross sectional view.

As shown in FIG. 1, an optical disc 100 has a recording surface on a disc main body with a diameter of about 12 cm, as in a DVD, for example. On the recording surface, the optical disc 100 is provided with a center hole 1 as the center; (i) a power calibration area PCA; (ii) a recording management area RMA; (iii) a lead-in area 101 having a control data zone CDZ and a narrow burst cutting area NBCA; (iv) a data area 102; and (v) a lead-out area 103.

Incidentally, as described later, one specific example of the “partial recording area” of the present invention is the aforementioned recording management area RMA or the lead-in area such as the control data zone CDZ. Moreover, the narrow burst cutting area NBCA is a recording area in which judgment information is recorded in advance, wherein the judgment information allows various attributes of the optical disc to be judged. More specifically, the NBCA allows the judgment information to be recorded at low density in a barcode shape over a plurality of tracks, and the NBCA also allows the judgment information to be reproduced only by rotational control for the optical disc, without tracking control. As a specific example of the judgment information using the NBCA, for example, a manufacturing number unique to each optical disc 100, i.e. a media ID, or the like can be listed.

Moreover, at least one recording layer is laminated, for example, on a transparent substrate not illustrated of the optical disc 100. In each recording area of the recording layer, for example, tracks 50 such as a groove track and a land track are alternately provided, spirally or concentrically, centered on the center hole 1. Moreover, on the tracks 50, record information (data) is divided and recorded by a unit of ECC block 51. The ECC (Error Correction Code) block 51 is a record information management unit by which the data can be error-corrected.

In particular, in the data area 102, first encryption information, such as a title key, based on an encryption system, such as CSS, and encrypted contents encrypted by the first encryption information, such as a title key, are recorded. More specifically, the first encryption information such as a title key is encrypted by second encryption information such as a disc key and a disc key set.

Incidentally, the present invention is not particularly limited to the optical disc having the five areas. For example, even if the lead-in area 101 or the lead-out area 103 does not exist, the data structure or the like explained below can be established. Moreover, the lead-in area 101 or the lead-out area 103 may be further segmentalized.

(1-2) Address Which Can Specify Position of Recording Area of Optical Disc

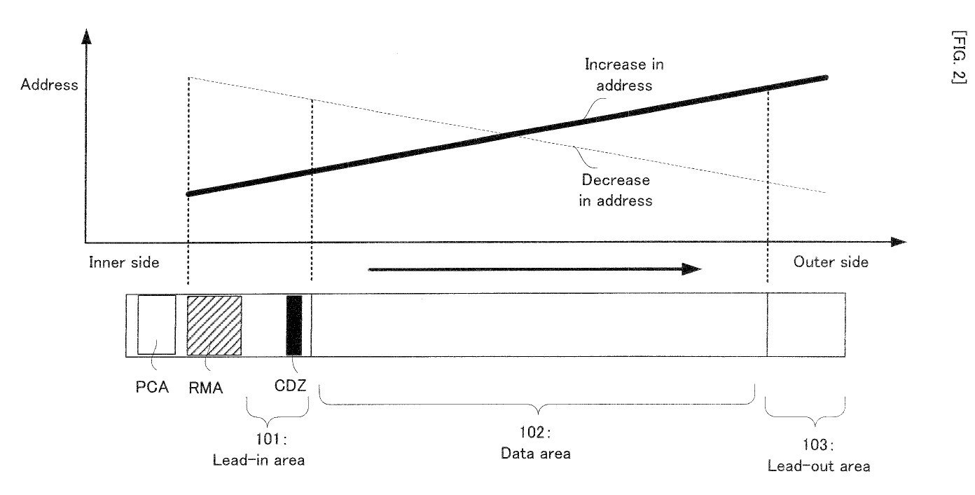

Next, with reference to FIG. 2, an explanation will be given on a relation between a recording area of the optical disc and an address which can specify the positions of the recording areas. FIG. 2 is a conceptual graph showing the relation between the recording area of the optical disc in the example of the information recording medium of the present invention and the address which can specify the position of the recording area. Incidentally, the vertical axis denotes an address value such as a sector number and a land pre-pit address, and the horizontal axis denotes a relative position in the radial direction of the optical disc.

As shown in FIG. 2, the recording areas of the optical disc 100 in the example of the information recording medium of the present invention are provided with (i) the power calibration area PCA; (ii) the recording management area RMA; (iii) the lead-in area 101 having the control data zone CDZ; (iv) the data area 102; and (v) the lead-out area 103, from the inner side to the outer side, as described above. Incidentally, in the RMA and the CDZ, various management information may be recorded. The management information is various information for managing the information recording medium, such as (ii-1) information about recording features such as an optimum recording power, (ii-2) attribute information for specifying the type of media, and (ii-3) information for specifying the positions of various recording areas. In particular, an encryption key in the present invention may be recorded in advance (i.e. prerecorded), for example, in the CDZ, under management by a content holder. On the other hand, the record data such as contents encrypted by the encryption key may be recorded by an information recording/reproducing apparatus which corresponds to the optical disc and which will be described later.

Moreover, as shown in FIG. 2, for example, if the address which can uniquely specify the position of the recording area of the aforementioned optical disc 100 is a physical sector number (or a sector number) of sectors which constitute the ECC block, the address in the recording areas of the optical disc 100 may be increased as an optical pickup is displaced from the inner side to the outer side (refer to a thick solid line in FIG. 2). Alternatively, for example, if the address which can uniquely specify the position of the recording area is a land pre-pit address, the address in the recording areas of the optical disc 100 may be reduced as the optical pickup of the information recording/reproducing apparatus described later is displaced from the inner side to the outer side (refer to a thin dotted line).

(1-3) Radial Position of Reproduction Setting Area In Which Special Groove is Formed

Next, an explanation will be given on the radial position of a reproduction setting area 101a; in which a special groove is formed in a partial area; which is firstly accessed when the recorded record information is reproduced; and which is to identify whether or not to allow the reproduction of the record information, in the example.

Specifically, in at least one of the following two types of radial positions, the groove is preferably formed that is defined to obtain a push-pull signal; in which at least one of its width and depth is less than or equal to a predetermined value. In other words, the first type is a radial position of “22.3 (mm: millimeter) to 35 (mm)” from the center of the optical disc. The second type is a radial position of “22.6 (mm: millimeter) to 35 (mm)” from the center of the optical disc. In particular, at these radial positions, the depth of the groove in the groove track, is preferably shallower (i.e. less) than a standard quantity.

This is derived from the following reason; namely, in the DVD-ROM regulation (or standard), the following two conditions need to be satisfied. The first condition is that the radial position of the start position of the lead-in area is located inner than 22.6 (mm) from the center of the optical disc. The second condition is that the radial position of the outermost portion of the recording area with information recorded, is located outer than 35 (mm) from the center of the optical disc.

On the other hand, in the regulation (or standard) of the conventional single-layer recording type optical disc (i.e. DVD-R SL (i.e. Single Layer)) and dual-layer recording type optical disc (i.e. DVD-R DL), the following three conditions need to be satisfied. The first condition is that the start radial position of the recording management area is about 22.3 (mm) from the center of the optical disc. The second condition is that the radial position of the start position of the lead-in area is about 22.6 (mm) from the center of the optical disc. The third condition is that radial position of the outermost circumference of the recording area with information recorded, is outer than 35 (mm) from the center of the optical disc.

Moreover, for example, the area which is firstly accessed when the recorded record information such as record data is reproduced; which allows the judgment of whether or not to allow the reproduction of the record information; and in which a laser beam is focused to identify whether or not to be recording media; is preferably placed in a place where information has been recorded, for the purpose of realizing a quick reproduction operation.

As described above, on the basis of the aforementioned six (=2+3+1) conditions, it is preferable to make the depth of the groove in the groove track shallower (i.e. less) than the standard quantity; such that the detection amount of the push-pull signal is less than a predetermined amount (i.e. a value that satisfies the DVD-R standard), at least at the radial position of “22.6 (mm) to 35 (mm)” from the center of the optical disc. Moreover, for an information recording apparatus (i.e. recorder), it is preferable to make the depth of the groove in the groove track shallower (i.e. less) than the standard quantity, at the radial position of “22.3 (mm) to 35 (mm)” from the center of the optical disc.

Incidentally, the standard quantity herein indicates the depth of the groove in the groove track which is set to the extent that can detect the push-pull signal satisfying the DVD-R standard described later. Moreover, the depth of the groove not only in the partial groove track but also in the entire groove track, may be uniformly set shallow.

Moreover, incidentally, the entire recording area or partial recording area, such as the reproduction setting area, may be set to have a straight groove shape; in which there is no wobble; and in which at least the depth of the groove in the groove track is reduced. Alternatively, wobble may be formed which has a frequency sufficiently higher (e.g. twice or more higher) than a wobble frequency determined in the DVD-R standard. The important thing is that the recording area is shaped such that the wobble cannot be detected by a general reproducing apparatus for DVD-R. This is because there is possibly a reproducing apparatus for performing medium judgment not only on the basis of the detection amount of the push-pull signal but also on the basis of the presence or absence of the wobble, in the disc type judgment. Thus, by setting the detection amount of the push-pull signal to be less than the aforementioned predetermined value; and by constituting the recording area not to detect the wobble; the possibility increases that allows the reproduction apparatus to identify that the information recording medium of the present invention is the DVD-ROM disc.

(1-4) One Specific Example of Groove Structure

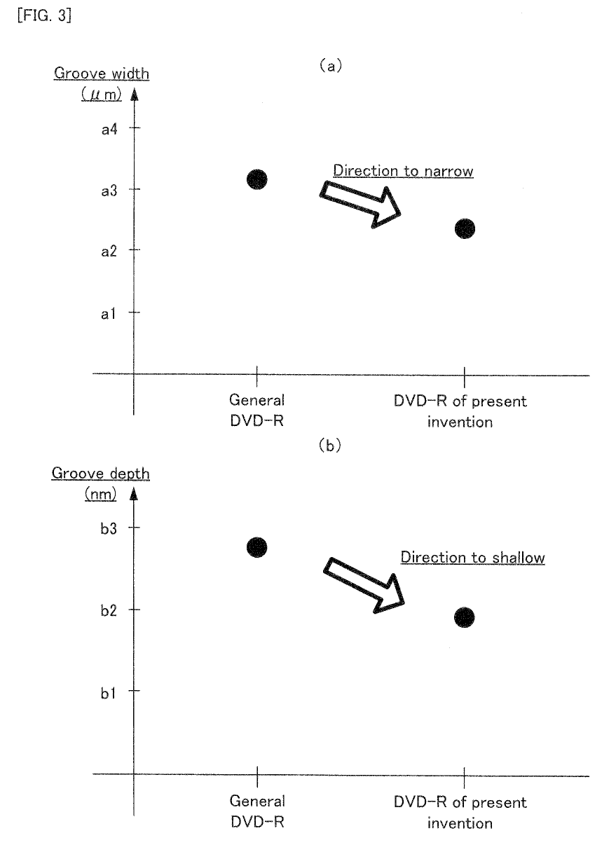

Next, with reference to FIG. 3 to FIG. 5, one specific example of a groove structure in the example of the present invention will be explained.

(1-4-1) Groove Shape

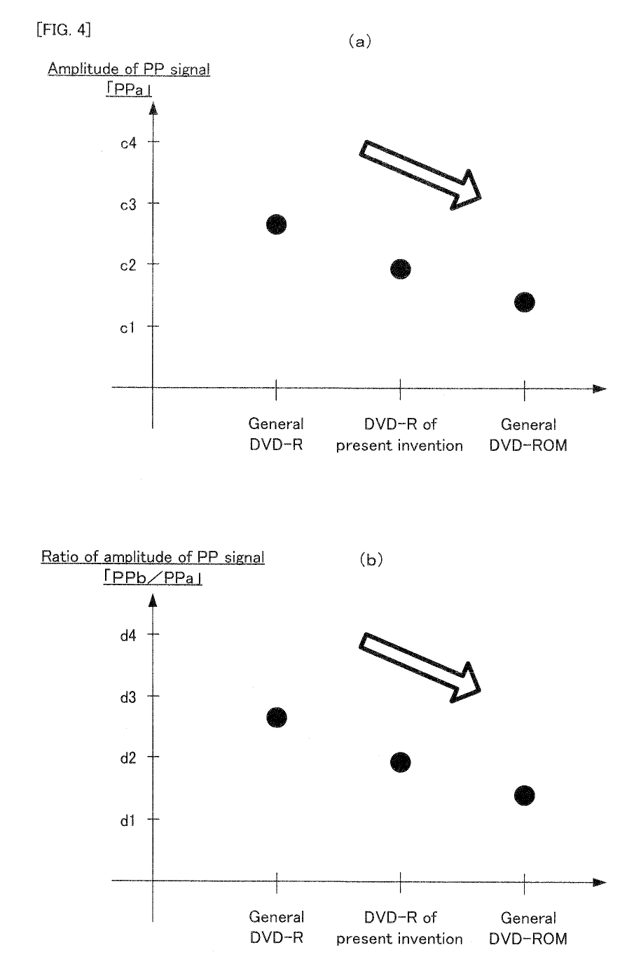

Firstly, with reference to FIG. 3 and FIG. 4, one specific example of the groove shape in the example of the present invention will be explained. FIG. 3 are graphs schematically showing a direction which changes the width and the depth of the groove in the example of the information recording medium of the present invention (FIG. 3(a) and FIG. 3(b)). FIG. 4 are graphs schematically showing a change in the value of the push-pull signal and a change in the ratio of the value of the push-pull signal; when the absolute value of the width or depth is defined in the example of the information recording medium of the present invention (FIG. 4(a) and FIG. 4(b)).

As shown in FIG. 3(a) and FIG. 3(b), the groove shape in the example, is defined to reduce at least the absolute value of the width or the depth in the aforementioned reproduction setting area of the entire groove track. By reducing the width or depth of the groove track in the reproduction setting area as described above, it is possible to make a detection level (i.e. amplitude level) of a push-pull signal lower than a value obtained from the general optical disc such as a DVD-R.

In general, in the standard of the recording type optical disc such as a DVD-R, the following conditional expressions (1) and (2) are defined to be satisfied, if the value (or level) of the normalized push-pull signal with information recorded in the recording area, is NPPa (i.e. Normal Push-Pull signal after); and the value of the normalized push-pull signal without information recorded in the recording area, is NPPb (i.e. Normal Push-Pull signal before).

0.22<NPPb<0.44 (1)

0.5<NPPr<1.0 (2)

(wherein, NPPr=NPPb/NPPa)

From the aforementioned two conditional expressions, the following conditional expression (3) is derived.

0.22<NPPa<0.88 (3)

Incidentally, the “normalization>” in the example, denotes a relative value of the detection level of the push-pull signal received in one portion of a light receiving element; if the total amount of the detection level of the push-pull signal on the entire light receiving element, is “1.0”. Specifically, in the case that the amounts of light received from four areas of a four-divisional light receiving element (e.g. photo detector) described later are “Ia”, “Ib”, “Ic”, and “Id”, respectively; the value of NPPa after recording and the value of NPPb before recording are defined by the following equations (4a) and (4b), respectively.

NPPa=|(Ia+Ib)−(Ic+Id)|/|Ia+Ib+Ic+Id| (4a)

NPPb=|(Ia+Ib)−(Ic+Id)|/|Ia+Ib+Ic+Id| (4b)

As described above, for example, in the DVD-R, the width and depth of the groove track are provided to obtain the push-pull signal having the predetermined value, from the recording area such as the RMA (recording management area) or the reproduction setting area.

In contrast, in the optical disc in the example, by adjusting at least one of the width and depth of the groove track; an amplitude of the push-pull signal obtained from at least one portion of the recording area such as the RMA or the reproduction setting area, is reduced to be less than the predetermined value. More specifically, the predetermined value may denote an amplitude that is substantially equivalent to the amplitude of the push-pull signal obtained from DVD-R, for example. Incidentally, in the aforementioned specific example, the predetermined value denotes an amplitude with a NPPb being as a value of “0.22”.

In addition, according to quantitative analysis by the present inventors; it is found that the detection level of the push-pull signal can be reduced by reducing the width or the depth of the groove track in the reproduction setting area (refer to FIG. 3 and FIG. 4). Specifically, it is found that the detection level of NPPa can be reduced, for example; by adjusting the depth of the groove track from 140 (nm: nanometer) which is general value, to 100 (nm).

When reproducing the record information recorded in the partial area of the recording area including the reproduction setting area; a conventional player (i.e. general information recording/reproducing apparatus) obtains only a signal with a smaller value than the push-pull signal obtained from the recording type information recording medium; so that the general information recording/reproducing apparatus judges that the information recording medium of the present invention is not a recording type disc but a read-only information recording medium such as a DVD-ROM. As a result, the conventional player can perform a reproduction process on the information recording medium of the present invention, as same as in the general read-only information recording medium such as a DVD-ROM.

As a result, owing to the aforementioned recording type information recording medium, which is defined to obtain the push-pull signal in which at least one of the width and depth of the track has the absolute value that is less than or equal to the predetermined value; it allows general users to be supplied with the contents whose copyright is protected by the encryption system, such as CSS; and it allows the supplied contents to be reproduced by a conventional player appropriately and simply. Therefore, according to the information recording medium of the present invention, it is possible to achieve both protecting copyright for the contents and maintaining reproduction compatibility.

Incidentally, the groove may be formed being defined to obtain the push-pull signal which is less than or equal to the predetermined value, from not only the partial groove track but also the entire groove track.

As a result, without being influenced by the position of the reproduction setting area described above, the conventional player can perform the reproduction process on the information recording medium of the present invention, as in the general read-only information recording medium.

(1-4-2) Groove Shape and Structure

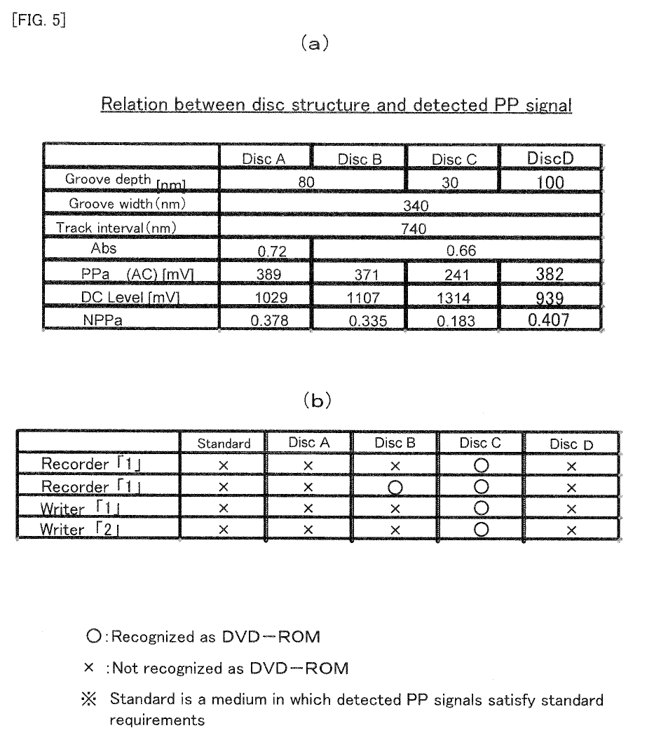

Next, with reference to FIG. 5, one specific example of the groove shape and structure in the example of the present invention, will be explained. FIG. 5(a) is a table numerically showing a correlation among a thickness of a pigment film (Abs), a groove depth (nni), a groove width (nm), a track interval (mm), a detection amount of a push-pull signal after recording (mV), and a normalized push-pull signal value (NPPa) in the example of the information recording medium of the present invention. Incidentally, “Abs” is a unit indicating light absorbance (i.e. the degree of absorption of the light), and it is used as an index indicating the film thickness (i.e. thickness) of the pigment film. Specifically, the smaller the value of “Abs” is, the thinner the thickness of the pigment film is. FIG. 5(b) is a table showing a result; when reproduction is tried by an information reproducing apparatus which can judge the type of an optical disc at a amplitude (i.e. detection level) of the push-pull signal, with respect to the recording-type disc on which contents protected by CSS are recorded, in the example of the information recording medium of the present invention.

According to the study by the present inventors, as shown in detection results in “Disc A” and “Disc B” in FIG. 5(a); it is found that if the thickness of the pigment film is reduced without a change in the depth of the groove, the detection amount of the push-pull signal decreases.

Moreover, as shown in detection results in “Disc B”, “Disc C”, and “Disc D” in FIG. 5(a); it is found that if the depth of the pigment film reduces without a change in the thickness of the groove, the detection amount of the push-pull signal reduces.

As a result, as shown in results in “Recorder (1)”, “Recorder (2)”, “Writer (1)”, and “Writer (2)” in FIG. 5(b), on the basis of this study; it can be found that many or most of information reproducing apparatuses or information recording/reproducing apparatuses to be able to judge the type of the optical disc at the push-pull signal amplitude (i.e. detection level), judge the type not to be the recording type optical disc such as a DVD-R but to be the readonly type optical disc such as a DVD-ROM; if the value of NPPa of the loaded optical disc is near “0.183”. In other words, it can be proved that many or most of information reproducing apparatuses or information recording/reproducing apparatuses, reproduce DVD-R media; in which the contents protected under the CSS encryption system are recorded.

From the aforementioned study; it is found that the push-pull signal obtained from the information recording medium, has the amplitude that has the predetermined value or less; by setting the width of the groove to about “½” or less of the track interval of the recording tracks; and by setting the depth of the groove to about “¼” or less of the groove width. As a result, it can be proved; that the aforementioned information recording medium of the present invention is judged to be the read-only type optical disc such as a DVD-ROM, on many or most of information reproducing apparatuses or information recording/reproducing apparatuses.

### (2) Information Reproducing Apparatus

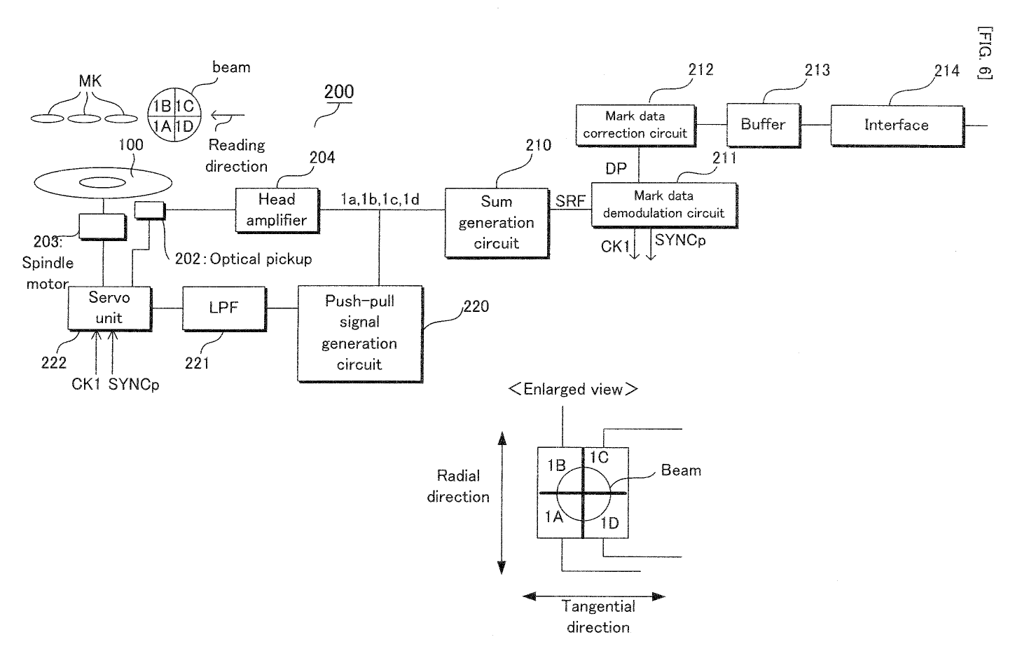

Next, with reference to FIG. 6, an example of the information reproducing apparatus of the present invention will be explained in detail. In particular, in the example, the information reproducing apparatus of the present invention is applied to an information recording/reproducing apparatus for optical discs.

(2-1) Basic Structure

Firstly, with reference to FIG. 6, an explanation will be given on the basic structure of an information recording/reproducing apparatus 200 in the example of the information reproducing apparatus of the present invention. FIG. 6 is a block diagram showing the entire structure of the information recording/reproducing apparatus 200 in the example of the information recording medium of the present invention.

The information recording/reproducing apparatus 200 is provided with the optical disc 100, an optical pickup 202, a spindle motor 203, a head amplifier 204, a sum generation circuit 210, a mark data demodulation circuit 211, a mark data correction circuit 212, a buffer 213, an interface 214, a push-pull signal generation circuit 220, a low pass filter 221, and a servo unit 222.

In the optical disc 100, mark data DP synchronized with a first clock signal CK1 is recorded by the length of a record mark MK. The first clock signal CK1 of a RF reproduction signal component is a signal that can be generated by the information recording/reproducing apparatus 200 from the RF reproduction signal component of the optical disc 100 which varies in an almost constant cycle in accordance with wobbling or the like. In the example, the first clock signal CK1 is generated by the mark data demodulation circuit 211. Incidentally, in the example, the record mark MK can be interpreted as a pit, and the track is formed of this pit row.

The information recording/reproducing apparatus 200 is, more specifically, provided with the optical disc 202 for irradiating a reproduction beam on the optical disc 100 and for outputting a signal corresponding to reflected light; the spindle motor 203 for controlling the rotation of the optical disc 100; and the servo unit 222. The servo unit 222 is supplied with the first clock signal CK1 and a mark synchronization signal SYNCp. The servo unit 222 performs tracking servo and focus servo for performing relative positional control with respect to the optical disc 100 of the optical pickup 202, and spindle servo for controlling the rotation of the spindle motor 203, in synchronization with these signals.

The optical pickup 202 is provided with a four-divisional detection circuit not illustrated and a laser diode for irradiating a reproduction beam. The four-divisional detection circuit divides the reflected light of the reproduction beam into areas 1A, 1B, 1C, and 1D shown in the upper part of FIG. 6, and it outputs, to each area, a signal corresponding to the amount of light in each area. The head amplifier 204 amplifies each output signal from the optical pickup 202 and outputs a divisional reading signal 1a corresponding to the area 1A, a divisional reading signal 1b corresponding to the area 1B, a divisional reading signal 1c corresponding to the area 1C, and a divisional reading signal 1d corresponding to the area 1D.

The sum generation circuit 210 is provided with an addition circuit for adding the divisional reading signals 1a, 1b, 1c, and 1d and for outputting a sum reading signal SRF. Incidentally, the sum reading signal SRF is a signal denoting the length of the record mark.

The mark data demodulation circuit 211 reproduces the mark data DP on the basis of the sum reading signal SRF and generates the first clock signal CK1. More specifically, the mark data demodulation circuit 211 generates reproduction data by demodulating the reproduced mark data DP with a predetermined table, with the mark synchronization signal SYNCp used as a reference position. For example, if RLL (1, 7) modulation, i.e. Run Length Limited (1, 7) Modulation is adopted as a modulation method, such a process that converts 3-bit mark data DP to 2-bit reproduction data is performed. Moreover, a descramble process is performed in which the order of the reproduction data is rearranged in accordance with a predetermined rule, and the processed reproduction data is outputted.

The reproduction data obtained in this manner is supplied to the mark data correction circuit 212 where an error correction process, an interpolation process, or the like is performed, and then, it is stored in the buffer 213. The interface 214 sequentially reads the data stored in the buffer 213, converts it into a predetermined format, and outputs it to external equipment.

The push-pull signal generation circuit 220 calculates (1a+1d)−(1b+1c) to generate the push-pull signal. The component (1a+1d) corresponds to the areas 1A and 1D on the left side with respect to a reading direction, while the component (1b+1c) corresponds to the areas 1B and 1C on the right side with respect to the reading direction. The value of the push-pull signal represents a relative positional relation between the reproduction beam and the track.

The push-pull signal is outputted to the servo unit 222 through the low pass filter 221. The servo unit 222 performs tracking control on the basis of the push-pull signal. Specifically, the value of the push-pull signal standardized can be calculated by the following equation (5) on the push-pull signal generation circuit 220.

“value of the push-pull signal standardized”={(1a+1d)−(1b+1c)}/(1a+1b+1c+1d) (5)

As shown in the equation (5), the value of the push-pull signal standardized is calculated on a division circuit for outputting a quotient obtained by dividing the push-pull signal by the sum of the push-pull signals. On the basis of the push-pull signal outputted from this arithmetic circuit, it is possible to obtain the stable push-pull signal in which a variation in the absolute value of the push-pull signal is corrected and in which the variation is caused by a change in local reflectance before or after the user data is recorded. Incidentally, in terms of the circuit, the aforementioned push-pull signal value PP denotes the amplitude (Peak to peak value) of a signal outputted from the low pass filter of the signal of (1a+1d)−(1b+1c). On the other hand, the value NPP of the push-pull signal standardized denotes the amplitude (Peak to peak value) of a signal outputted from the low pass filter of the signal of {(1a+1d)−(1b+1c)}/(1a+1b+1c+1d). Incidentally, in the lower part of FIG. 6, the radial direction is shown in a direction along the areas 1A and 1B, and the tangential direction is shown in a direction along the areas 1A and 1D.

### (3) Manufacturing Procedure (Change in Groove Shape of Groove Track)

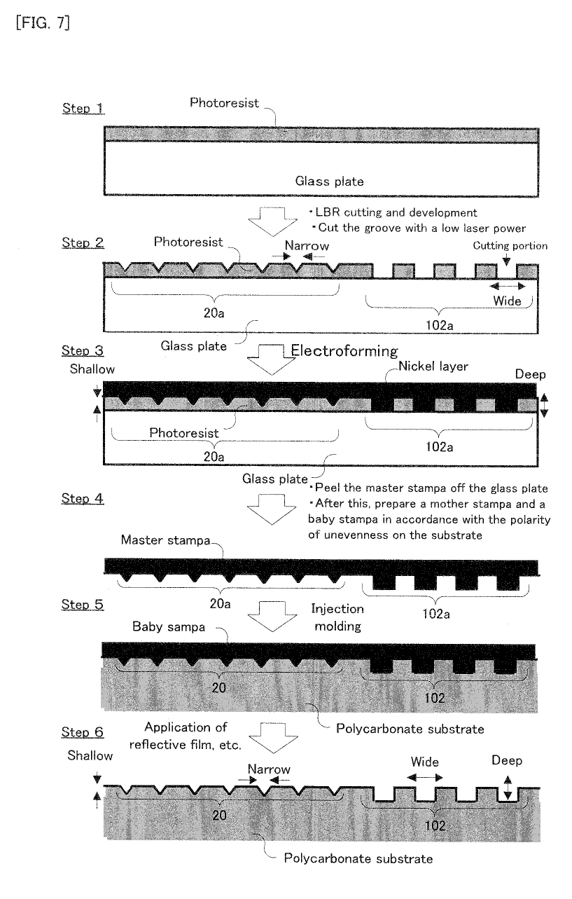

Next, with reference to FIG. 7, as a manufacturing procedure, an explanation will be given on a local change in the width and/or depth of the groove, which is the groove shape of the groove track. FIG. 7 is a schematic diagram schematically showing a procedure of manufacturing the information recording medium of the present invention.

As shown in a step 1 in FIG. 7, in a glass plate, so-called spin coating is performed, in which viscous photoresist (e.g. photosensitive resin) is dropped and applied with a uniform thickness while the glass plate is rotated.

Then, as shown in a step 2 in FIG. 7, a portion 20a of the glass plate for changing the groove shape is irradiated with a cutting laser beam, such as electron rays and ultraviolet rays, with a relatively low power, compared to a laser power in a portion 102a of the glass plate for forming the data area. In the portion irradiated with the cutting laser beam as described above, the bonding of the photoresist is cut by the light energy at molecular level. Thus, holes are provided by dipping it in a developing solution, and a cutting portion is formed in each of the portion 20a and the portion 102a.

As a result, it is possible to relatively reduce the width and the depth of the groove in the portion 20a of the glass plate for changing the groove shape. Specifically, the width of the groove can be determined by the beam diameter of the cutting laser beam in addition to the laser power. Moreover, the depth of the groove can be determined by the thickness of the photoresist in addition to the laser power. Incidentally, the laser power desirably appropriately corresponds to the sensitivity of the photoresist which constitutes the plate.

Then, as shown in a step 3 in FIG. 7, nickel is laminated on a thin film of nickel in an electroforming process, and a thick nickel layer is formed on the glass plate.

Then, as shown in a step 4 in FIG. 7, the nickel layer is peeled off the glass plate to prepare a master stampa. From the master stampa, a mother stampa and a baby stampa are prepared through the same electroforming process. The baby stampa is through the transfer twice, sothat it has the same unevenness as in the mother stampa.

Then, as shown in a step 5 in FIG. 7, a resin substrate, i.e. a polycarbonate substrate, is prepared from the baby stampa by an injection molding machine.

Lastly, as shown in a step 6 in FIG. 7, a reflective film is applied. For example, a dummy substrate or a substrate for holding a signal surface is applied to prepare the optical disc.

As a result of the aforementioned manufacturing procedure, it is possible to locally change at least one of the width and depth of the groove, which is the groove shape of the groove track of the information recording medium of the present invention. In other words, it is possible to relatively reduce the width of the groove in the groove track, which is one portion of the recording area, such as the reproduction setting area, in the information recording medium of the present invention, compared to the width of the groove in the groove track in the data area 102. In addition, it is possible to relatively reduce the depth of the groove in the groove track, which is one portion of the recording area, such as the reproduction setting area, in the information recording medium of the present invention, compared to the depth of the groove in the groove track in the data area 102. As a result, in the manufacturing procedure of an apparatus for manufacturing the information recording medium of the present invention, the glass plate is irradiated with the cutting laser beam with a laser power locally different, so that it is possible to locally change at least one of the width and depth of the groove, which is the groove shape of the groove track of the information recording medium of the present invention. Incidentally, the width and depth of the groove, which is the groove shape of the groove track of the information recording medium of the present invention, may be not only locally changed but also uniformed as a result. It is only necessary to adjust the width or depth of the groove in the groove track such that at least the push-pull signal detected from the reproduction setting area is less than the push-pull signal detected from the recording type information recording medium such as a DVD-R.

In the aforementioned examples, as one specific example of the information recording medium, an explanation is given on the single-layer type optical disc in which recording or reproduction can be performed by a laser beam such as Blu-rays, red LD light, or infrared rays. In addition, the present invention can be also applied to a multilayer type (multiple layer type) optical disc provided with two or more recording layers. Moreover, it can be also applied to other various information recording media which support high-density recording or a high transfer rate.

Moreover, the aforementioned examples describe the case where the present invention is applied particularly to a DVD-R as the information recording medium; however, the present invention is not limited to this examples and can be also applied to a DVD-RW, a DVD+R, and a DVD-RW.

The pesent invention is not limited to the aforementioned examples, but various changes may be made, if desired, without departing from the essence or spirit of the invention which can be read from the claims and the entire specification. An information recording medium and a method of manufacturing the information recording medium, all of which involve such changes, are also intended to be within the technical scope of the present invention.

### INDUSTRIAL APPLICABILITY

The information recording medium and the method of manufacturing the information recording medium of the present invention can be applied to an information recording medium such as a DVD (Digital Versatile Disc), a BD (Blu-ray Disc), and a CD (Compact Disc), in which recording and reproduction can be performed by irradiating a laser beam.

1-19. (canceled)

20. An information recording medium; which is an optical recording medium; in which a groove is formed along a recording track; and which is irradiated with a laser beam for recording or reproduction, wherein
a push-pull signal less than a predetermined value, is obtained from at least a partial area of the groove;
the predetermined value is equal to “0.22”; if the push-pull signal detected from the partial area, is normalized by an entire amount of light detected from the partial area.

21. The information recording medium according to claim 20, wherein the predetermined value is a detection amount of the push-pull signal determined in a DVD-R standard or DVD-RW standard.

22. The information recording medium according to claim 20, wherein the predetermined value is a detection amount of the push-pull signal determined in a DVD+R standard or DVD+RW standard.

23. The information recording medium according to claim 20, wherein the partial area is in a radial range of “22.3 to 35.0 (mm: millimeter)” from the center of said information recording medium.

24. The information recording medium according to claim 20, wherein the partial area is an area that is not included in a data area.

25. The information recording medium according to claim 20, wherein the partial area is included in a lead-in area.

26. The information recording medium according to claim 20, wherein the partial area is included in a CDZ (control data zone)

27. The information recording medium according to claim 20, wherein a straight groove is formed in the partial area.

28. The information recording medium according to claim 20, wherein wobble is formed in the partial area.

29. The information recording medium according to claim 20, wherein wobble with a wobble frequency substantially twice the wobble frequency determined in a DVD-R standard or DVD-RW standard, is formed in the partial area.

30. The information recording medium according to claim 20, wherein the push-pull signal less than the predetermined value, is obtained from an entire area of the groove.

31. The information recording medium according to claim 20, wherein the push-pull signal obtained from the partial area, is less than a push-pull signal obtained from another partial area of the groove.

32. A method of manufacturing an information recording medium; in which a groove is formed along a recording track; and which is irradiated with a laser beam for recording or reproduction; wherein a push-pull signal less than a predetermined value, is obtained from at least a partial area of the groove; the predetermined value is equal to “0.22”; if the push-pull signal detected from the partial area, is normalized by an entire amount of light detected from the partial area, said method comprising:
a changing process of changing a depth or width of the groove in the partial area; and
an adjusting process of adjusting the push-pull signal obtained from the changed partial area to be less than the predetermined value.

33. The method of manufacturing an information recording medium according to claim 32, wherein the predetermined value is a detection amount of the push-pull signal determined in a DVD-R standard or DVD-RW standard.

34. The method of manufacturing an information recording medium according to claim 32, wherein
said changing process changes the width of the groove in the partial area to “½” or less of a track interval of the recording track, and
said adjusting process adjusts the push-pull signal obtained from the changed partial area to be less than the predetermined value.

35. The method of manufacturing an information recording medium according to claim 32, wherein
said changing process changes the depth of the groove in the partial area to “¼” or less of the groove width, and
said adjusting process adjusts the push-pull signal obtained from the changed partial area to be less than the predetermined value.
